(19) United States
(12) Patent Application Publication
(10) Pub. No.: US 2015/0339100 A1
(43) Pub. Date: Nov. 26, 2015

(54) ACTION DETECTOR, METHOD FOR DETECTING ACTION, AND COMPUTER-READABLE RECORDING MEDIUM HAVING STORED THEREIN PROGRAM FOR DETECTING ACTION

(71) Applicant: FUJITSU LIMITED, Kawasaki-shi (JP)

(72) Inventor: Katsushi Miura, Atsugi (JP)

(21) Appl. No.: 14/815,310

(22) Filed: Jul. 31, 2015

Related U.S. Application Data
(63) Continuation of application No. PCT/JP2013/058045, filed on Mar. 21, 2013.

(51) Int. Cl. G06F 3/16; G06F 3/01

(52) U.S. Cl. CPC G06F 3/167; G06F 3/011; G06F 3/017

(57) ABSTRACT

A motion detector that detects an action of a limb includes a processor. The processor is configured to execute a process of extracting, as time-series data, a cepstrum coefficient of vibration generated by the action of the limb; generating time-division data by time-dividing the time-series data; and classifying a basic unit of the action corresponding to each of the time division data on the basis of the cepstrum coefficient included in the time-division data.

### CROSS-REFERENCE TO RELATED APPLICATIONS

This application is a continuation application of International Application PCT/JP2013/058045, filed on Mar. 21, 2013 and designated the U.S., the entire contents of which are incorporated herein by reference.

### FIELD

The embodiment discussed herein is related to an action detector that detects an action of a limb, a method for detecting an action, and a computer-readable recording medium having stored therein a program for detecting an action.

### BACKGROUND

There has been developed a technique to recognize an action of a person on the basis of information detected with, for example, a video camera, an acceleration sensor, and a microphone. In recent years, in accordance with development of small sensor and improvement of communication infrastructure, various wearable computers functioning as handsfree input interfaces have been proposed.

In known techniques, a wearable device put on a wrist or a finger detects an action of the fingertip of the wearer and determines the action to be an action of typing a virtual keyboard or an action of inputting commands (see Patent Literatures 1-4). A wearable device senses vibration (vibration conducted through the body) generated by an action, the sound or the acceleration of the vibration, and myopotential. Analysis on time-series data of such sensed data determines an action and consequently an input operation corresponding to the action is accomplished.
[Patent Literature 1] Japanese Laid-Open Patent Publication No. 07-121294
[Patent Literature 2] Japanese Laid-Open Patent Publication No. 10-198478
[Patent Literature 3] Japanese National Publication of International Patent Application No. 2005-525635
[Patent Literature 4] Japanese Laid-Open Patent Publication No. 11-338597

Unfortunately, such conventional techniques have difficulty in distinguish one from a large variety of actions having different action times, which consequently makes it difficult to determine a robust action. Here, the difficulty will now be explained in relation to an example of a difference between a typing action and a tapping action with finger, which is to be determined by a wearable device being put on a wrist.

An action of typing is an action that a finger impacts with an article, and generates pulse-form vibration. A conceivable width of extracting time-series data representing this vibration is set in consideration of an impact time and/or an impact speed of a finger with an article. Here, since an impact time and/or an impact speed seem to fall within respective constant ranges, it is expected that setting the width of extracting time-series data to be a substantially-fixed length would not much degrade the precision of the determination.

In contrast to the above, an action of tapping with a finger is an action that the finger does not impact with an article and generates vibration corresponding to the action time of the finger. Accordingly, there is a possibility that setting the width of extracting time-series data to be a substantially-fixed length would degrade the precision of determination of the action.

Even the same action, a rapid action takes a different time from a time that a slow action takes. This makes it difficult to set an appropriate width of extracting time-series data even for the same action. Such difficulty in setting a width of extracting time-series data is one of the factors to hinder the improvement in precision of determining an action.

### SUMMARY

There is disclosed a motion detector that detects an action of a limb, the motion detector includes an extractor that extracts as time-series data, a cepstrum coefficient of vibration generated by the action of the limb, and a generator that generates time-division data by time-dividing the time-series data; and a classifier that classifies a basic unit of the action corresponding to each of the time division data on the basis of the cepstrum coefficient included in the time-division data.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a perspective view illustrating an action detector according to a first embodiment;

FIG. 2 is a block diagram schematically illustrating an example of the configuration of an action detector;

FIG. 3 is a configurational block diagram schematically illustrating a program for detecting an action;

FIG. 4 is a graph depicting an example of body-conducted sound data;

FIG. 5 is a graph depicting an example of a cepstrum coefficient (MFCC primary component) extracted from the body-conducted sound data of FIG. 4;

FIG. 6 is a diagram illustrating types of action primitive;

FIG. 7 is a diagram illustrating a manner of classifying action primitives;

FIG. 8 is a diagram explaining an inclination and dispersion of a cepstrum coefficient;

FIGS. 9A and 9B are graphs each depicting an example of a cepstrum coefficient;

FIGS. 10A and 10B are graphs each depicting an example of a cepstrum coefficient;

FIG. 11 is a model diagram explaining a probability model related to action estimation;

FIG. 12 is a flow diagram illustrating a succession of procedural steps of a method for detecting an action of the first embodiment;

FIG. 13 is a flow diagram illustrating a succession of procedural steps of a method for detecting an action of the first embodiment; and

FIGS. 14A and 14B are graphs each depicting an example of a cepstrum coefficient;

### DESCRIPTION OF EMBODIMENTS

Hereinafter, description will now be made in relation to an action detector, a method for detecting an action, a program for detecting an action, and a computer-readable recording medium having stored therein a program for detecting an action by referring to the accompanying drawings. The following embodiment is a merely example and there is no intention to exclude various modifications and application of techniques that are not described in the following embodiment. The configurations of the embodiment can be variously modified without departing from the respective purposes and may be selected, omitted, and combined (with a modification).

1. Terminology

An action detector, a method for detecting an action, a program for detecting an action, and a computer-readable recording medium having stored therein a program for detecting an action of the first embodiment receive vibration generated by an action of a limb of a wearer, and detect and determine a type of action on the basis of the parameter characterizing the vibration. The word “vibration” here includes, for example, vibration of muscle(s) and bone(s); vibration generated by contact and impact of a limb with an article; and vibration generated by contact and impact of limbs. Hereinafter, such vibration generated by an action of a limb of a wearer is also called “body-conducted sound”.

An action is classified into action primitives, which can be regarded as basic units of the action. An action primitive is a cluster of basic actions specified by the characteristics of its body-conducted sound. This embodiment sets four types of action primitive of: a rest state, a motion state, an impact state, and a transition state. The “rest state” represents a state where the action of the limb is halting; the “motion state” represents a state where the limb is moving; the “impact state” is a state where an impact or an abrupt action occurs; and the “transition state” is an intermediate state of the above three states (or a state where the type of action is not clearly specified).

It is satisfactory that the types of action primitive are classified into at least the “rest state” and a “non-rest” state from the viewpoint of grasping the time points of the start and the end of an action. For this purpose, the “non-rest state” may be defined as an integrated state including the motion state, the impact state, and the transition state. In this case, the time when the type of action primitive is changed from the rest state to the non-rest state can be regarded as the time point of the start of an action; and the time when the type of action primitive is changed from the non-rest state to the rest state can be regarded as the time point of the end of the action.

Examples of an action to be detected and determined in this embodiment are wagging a finger, waving a hand, typing, clapping hands, turning a knob, tapping, flicking, and clasping. Further examples of an action in this embodiment are palmar/dorsal flexion, flexion/extension, radial/ulnar flexion, and pronation/supination. In addition to the above examples of action of a palm, a finger, and a thumb, the action detector can detect and determine an action of a foot or a toe. The action detector grasps, for each above action, information of the type, the order, the number, the duration time, and the intensity of each action primitive.

Classification of a type of action primitive is based on a cepstrum coefficient of the body-conducted sound. A cepstrum coefficient is a feature amount derived from a spectrum intensity of vibration and is a multivariate obtained by orthogonalization of a logarithm spectrum of the body-conducted sound. A cepstrum coefficient corresponds to a rate of change in different spectrum bands. If the spectrum of a body-conducted sound is expressed by a function f(ω) of a frequency ω, the cepstrum coefficient cₙ is calculated by, for example, the following Expression 1. The variable n in Expression 1 represents the order of the cepstrum coefficient (i.e., n=0, 1, 2, . . . ). Hereinafter, a cepstrum coefficient of the first order (n=1) is called a primary component of the cepstrum coefficient.

$${c}_{n} = \frac{1}{2 π} {\int }_{- π}^{π} {e}^{i n ω} log f ( ω ) d ω \\ ( = \frac{1}{2 π} {\int }_{- π}^{π} ( cos n ω + i sin n ω ) log f ( ω ) d ω ) \qquad ( Expression 1 )$$

A cepstrum coefficient used in this embodiment is a Mel Frequency Cepstrum Coefficient (MFCC). An MFCC is a cosine expansion coefficient of powers of bands obtained by multiplying the logarithm spectrum of the body-conducted sound by multiple band filters, in other words, an MFCC is a coefficient obtained through cosine transform or Fourier transform. An example of the band filters used here is a Mel filter bank (group of Mel band filters) having triangular windows defined by the Mel scale. The Mel scale is one of the human perceptual scale and has non-linear logarithmic relationship with a frequency ω. Expressing the number of band filters (the number of bands) by symbol N and the amplitude after filtering at the j-th band by symbol mⱼ (j=1, 2, . . . , N), the cₙ, which is the n-th-order component of the MFCC, is expressed in, for example, the following Expression 2.

$${c}_{n} = \sqrt{\frac{2}{N}} {\sum }_{j = 1}^{N} {m}_{j} cos \{ \frac{n π}{N} ( j - \frac{1}{2} ) \} \qquad ( Expression 2 )$$

In classifying types of action primitive, at least a primary component of the MFCC, preferably, a low-frequency band component (i.e., a low-frequency variable component), is used. A “low-frequency band component” is a component of the order n, which is one or more and a predetermined value X or less (n=1, . . . , X; where X is a natural number larger than one). Using at least a primary component c₁ of an MFCC satisfactorily detects and determines an action of a palm, a finger, and a thumb (hereinafter, the word “finger” includes the definition of the “thumb”). Furthermore, using a secondary component c₂ in combination with the primary component c₁ improves the precision in determining an action. The precision in determining an action more increases as a higher-order components are used in combination with the primary component c₁.

A cepstrum coefficient is used for estimating an action in addition to classifying the type of action primitive. As described above, classifying the type of action primitive preferably uses at least an MFCC primary component c₁, or may use a higher-order component in combination with the MFCC primary component c₁. Estimating an action does not always use a cepstrum coefficient as the parameter, which can be appropriately omitted. However, using a cepstrum coefficient enhances the precision in estimating an action, and using a higher-order cepstrum coefficient in combination with the primary component further improves the precision in estimating an action.

Examples of a parameter for determining an action are variables each related to a type, an order, the number, a duration time, the intensity of an action primitive, the above cepstrum coefficient, and variables each related to an inclination and dispersion of a cepstrum coefficient. Here, the inclination of a cepstrum coefficient is a parameter corresponding to the gradient per unit of time (an amount of a change within a minute time) of a cepstrum coefficient. The dispersion of a cepstrum coefficient is a parameter corresponding to an extent of variation of a cepstrum coefficient.

2. Action Detector

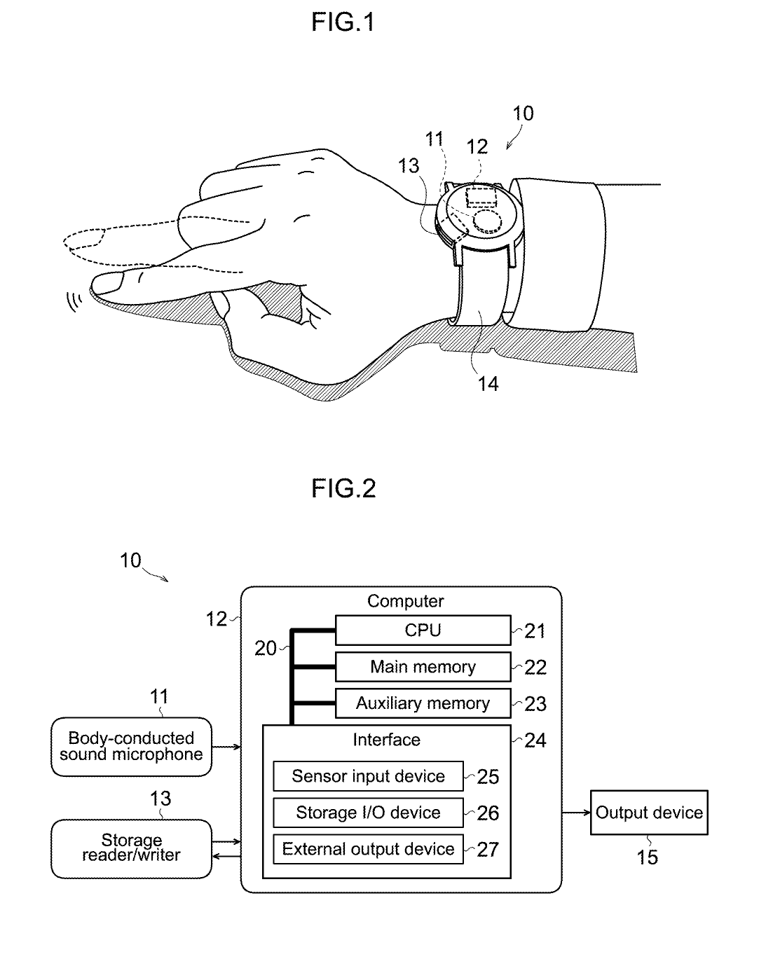

FIG. 1 is a perspective view illustrating an action detector 10 according to the first embodiment. In the illustrated example, the action detector 10 is a wristband-type wearable device, which is put on a wrist of the wearer. The action detector 10 includes a body-conducted sound microphone 11, a computer 12, and a storage reader/writer 13, and operates using electric power supplied from a non-illustrated power source (e.g., a button battery or an electric-power supplying cable). The action detector 10 is detachably put on the wrist of the wearer with, for example, a belt-type wristband 14.

The body-conducted sound microphone 11 is a microphone (sensor) that converts a sound wave of body-conducted sound into an electric signal, or a sensing device including, in addition to a microphone, a microprocessor, a memory, and a communication device. In this example, a sound pressure or a sound speed of vibration around the wrist is measured as time-series body-conducted sound data. As illustrated in FIG. 1, the body-conducted sound microphone 11 is disposed on the inner circumference of the action detector 10 and, when the wearer puts on the action detector 10, is used at close position of or in contact with the surface skin of the body. The body-conducted sound data measured by the body-conducted sound microphone 11 is sent to the computer 12 through a non-illustrated communication line or a non-illustrated communication device.

The computer 12 is an electronic calculator including a processor such as a CPU (Central Processing Unit) or an MPU (Micro Processing Unit), a ROM (Read Only Memory), a RAM (Random Access Memory), and an interface. The computer 12 has a function of detecting an action of the palm, and the fingers of the wearer of the action detector 10 on the basis of the body-conducted sound data sent from the body-conducted sound microphone 11 and determining the type of the action. The type of the action determined by the computer 12 is sent to the output device 15 through a non-illustrated communication line or a non-illustrated communication device.

The output device 15 is a device separate from the action detector 10, and has a function of, for example, outputting the type of action determined by the computer 12. For this purpose, the output device 15 preferably includes at least an output unit such as a monitor, a speaker, or a lamp. Furthermore, the output device 15 has a function of, for example, accepting an operational input corresponding to the type of the action determined by the computer 12. In this case, the action detector 10 functions as an input interface of the output device 15. In other words, the action of the palm, and the fingers is used as an input signal to operate the output device 15. Accordingly, examples of the output device 15 connected to the action detector 10 is a server, a personal computer, a tablet terminal, a mobile terminal, and a communication processing terminal.

The storage reader/writer 13 is a device for reading data from and writing data into a removable medium, and is connected to the computer 12 via an interface. The computer 12 can execute a program stored in a removable medium as well as one stored in the internal memory. For example, a program for detecting an action of the first embodiment is stored in a removable medium and read by the storage reader/writer 13 into the computer 12, where the program is to be executed.

3. Computer

As illustrated in FIG. 2, the computer 12 includes a CPU 21, a main memory 22, an auxiliary memory 23, and an interface 24, which are connected to one another via a bus 20. The CPU 21 is a processor including a controller unit (controller circuit), a calculator unit (calculator circuit), and a cache memory (a group of registers). The main memory 22 is a memory device in which programs and data being used are stored, and is exemplified by a RAM and/or a ROM as the above example. The auxiliary memory 23 is a memory device in which programs and data that are to be retained for a longer time than the data stored in the main memory 22, and is exemplified by a ROM such as a flash memory.

The interface 24 is in charge of input/output (I/O) between the computer 12 and an external device. The interface 24 includes a sensor input interface 25, a storage input/output interface 26, and an external output interface 27.

The sensor input interface 25 functions as the interface between the body-conducted sound microphone 11 and the computer 12. Body-conducted sound data sent from the body-conducted sound microphone 11 is input via the sensor input interface 25 into the computer 12.

The storage input/output interface 26 functions as the interface between the storage reader/writer 13 and the computer 12. The storage input/output interface 26 reads data from and writes data into a removable medium mounted in the storage reader/writer 13 by transmitting an access command for reading or writing to the storage reader/writer 13. Body-conducted sound data measured by the body-conducted sound microphone 11 and information related to an action determined by the computer 12 can be read from or write into a removable medium being mounted in the storage reader/writer 13.

The external output interface 27 functions as the interface between the output device 15 and the computer 12. The type of an action determined in the computer 12 and the results of calculating by the computer 12 are sent via the external output interface 27 to the output device 15. The communication manner between an output device 15 and the computer 12 may be wired using a wired communication device or may be wireless using a wireless communication device.

4. Program

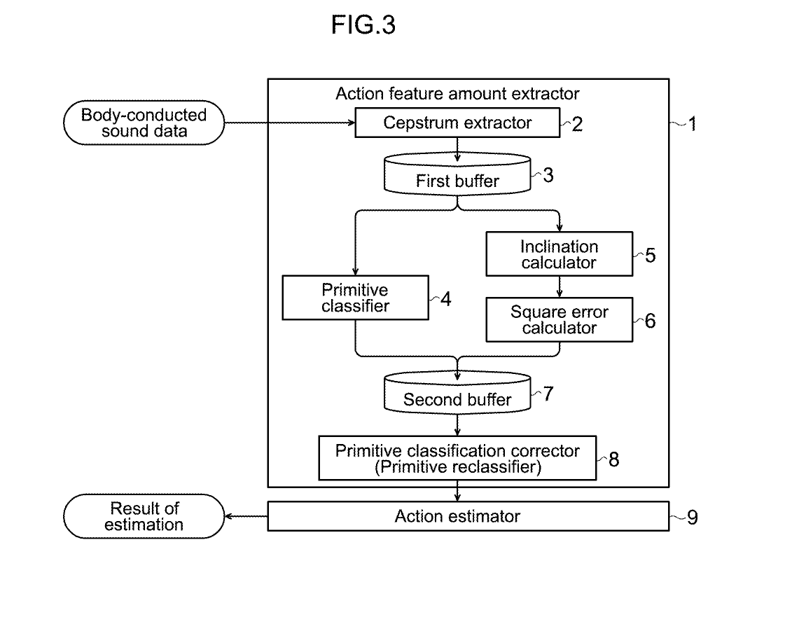

FIG. 3 is a block diagram schematically illustrating a process to be performed in the computer 12. The details of the process is stored in the auxiliary memory 23 or a removable medium, being in the form of, for example, an application program, and is expanded in a memory space of the main memory 22 and is then executed. The processing of this program is functionally divided into an action feature amount extractor 1 and an action estimator 9.

4-1. Action Feature Amount Extractor

The action feature amount extractor 1 extracts information characterizing an action from body-conducted sound data. In the illustrated example, the action feature amount extractor 1 extracts three kinds of information: an action primitive, an inclination of the MFCC, and a square error of the MFCC. These three kinds of information are calculated for each minute time of body-conducted sound data and converted into time-series data. The action feature amount extractor 1 includes a cepstrum extractor 2, a first buffer 3, a primitive classifier 4, an inclination calculator 5, a square error calculator 6, a second buffer 7, and a primitive classification corrector 8.

4-2. Cepstrum Extractor

The cepstrum extractor 2 (extractor) calculates a cepstrum coefficient of body-conducted sound data for each minute time. In the illustrated example, the cepstrum extractor 2 calculates at least an MFCC primary component c₁. An MFCC primary component c₁ is discretely calculated from the body-conducted sound data. An MFCC primary component c₁ is repeatedly calculated from body-conducted sound data input within a predetermined time period. The periodic cycle P of calculating an MFCC primary component c₁ is regarded as a regular cycle. The data group of MFCC primary components c₁ repeatedly calculated can be regarded as time-series data. Accordingly, the cepstrum extractor 2 has a function of extracting, as the time-series data, a cepstrum coefficient from the body-conducted sound data. If the cepstrum extractor 2 is configured to extract multiple cepstrum coefficients, each cepstrum coefficient is extracted as time-series data.

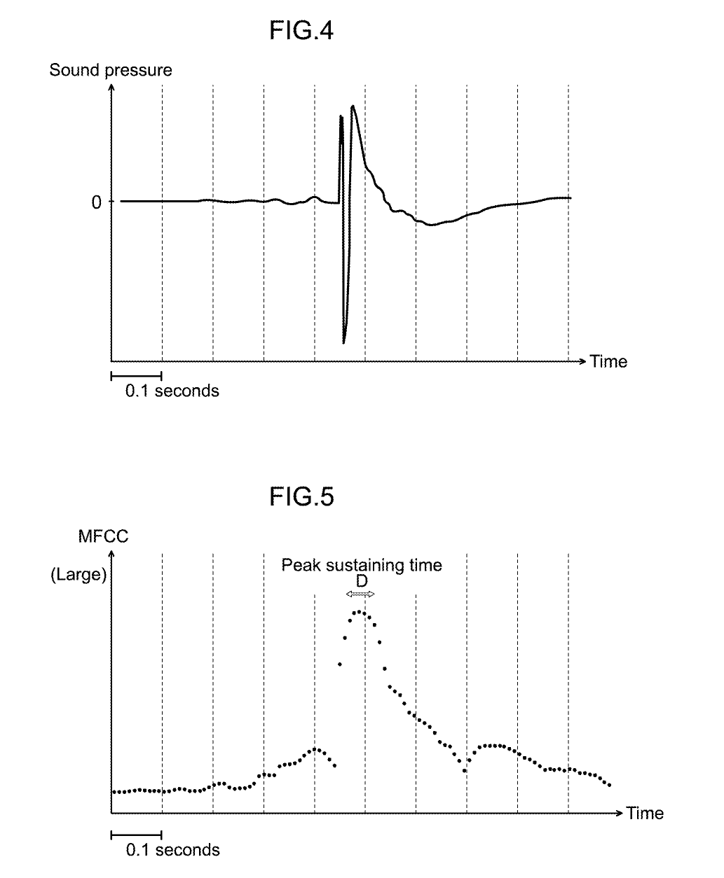

FIG. 4 is a graph depicting an example of body-conducted sound data representing an action of clapping hands and being input into the cepstrum extractor 2; and FIG. 5 is a graph depicting an example of a plot of an MFCC primary component c₁ corresponding to the body-conducted sound data of FIG. 4. Each data point in FIG. 5 is calculated from extracted body-conducted sound data of 0.1 seconds, and corresponds to a single MFCC primary component c₁. A pitch of a data point (i.e., the periodic cycle P of calculating an MFCC primary component c₁) is 0.01 seconds. The values of the MFCC primary components c₁ calculated here are sent to the first buffer 3.

As depicted in FIGS. 4 and 5, the peak of the MFCC primary component c₁ representing an action of clapping hands continues for about 0.04-0.05 seconds corresponding to the period for which the body-conducted sound data generated by the action of clapping hands largely fluctuates. From this feature, in order to determine the action of clapping hands, it is preferable to detect the peak sustained for about 0.04-0.05 seconds. Such a time period for which the MFCC primary component c₁ takes a value near the peak value is referred to as a peak sustaining time D. A preferable periodic cycle P of calculating an MFCC primary component c₁ in the cepstrum extractor 2 is set in the range equal to or shorter than the peak sustaining time D of a cepstrum coefficient generated by each action to be determined.

4-3. First Buffer

The first buffer 3 (generator) contains MFCC primary component c₁ of at least a predetermined time period. Specifically, the values of the MFCC primary component c₁ calculated in the cepstrum extractor 2 are stored in the time-series order. The first buffer 3 has a capacity affordable to store values of MFCC primary component c₁ for at least a time period equal to or longer than the peak sustaining time D. This means that, the first buffer 3 contains at least D/P values of the MFCC primary component c₁ of the periodic cycle P of calculating (here D>P). If the cepstrum extractor 2 calculates extract multiple cepstrum coefficients, the first buffer 3 preferably has a capacity affordable to store all the cepstrum coefficients.

In the first buffer 3 of this embodiment, four values of the MFCC primary component c₁ of the periodic cycle P of calculating of 0.01 seconds are stored as a set of a time-series data record. If the cepstrum extractor 2 calculates multiple cepstrum coefficients, the corresponding MFCC primary components are likewise included in time-series data records. The single set of the time-series data record is sent to the primitive classifier 4 and the inclination calculator 5. The time-series data record can be regarded as time-division data obtained by time-dividing the time-series data of the MFCC primary component c₁ (i.e., time-series cepstrum data). For this purpose, the first buffer 3 has a function as a generator that generates the time-division data through time-dividing the time-series data of the cepstrum coefficient.

After that, the first buffer 3 stores new values of the MFCC primary component c₁ in, for example, a FIFO (First-In First-Out) manner, and discards stored values of the MFCC primary component c₁ from the oldest as much as the overflow from its capacity, so that the time-series data record in the first buffer 3 is always updated. The periodic cycle R of updating the time-series data record may be set to be the same as or longer than the periodic cycle P of calculating an MFCC primary component c₁. In this embodiment, the time-series data record is updated every 0.02 seconds, which means that the time-series data record is updated each time two new values of the MFCC primary component c₁ are calculated. This periodic cycle R of updating, which corresponds to the cycle of classifying an action by a primitive classifier 4 that is to be described below, is preferably set within the range equal to or longer than the periodic cycle P of calculating and also equal to or shorter than the peak sustaining time D.

4-4. Primitive Classifier

The primitive classifier 4 (classifier) classifies the type of action of a minute time using the time-series data record being stored in the first buffer 3 and corresponding to the minute time. Here, the action of each minute time is determined to be one of multiple action primitives. A minute time of this embodiment has a length of 0.04 seconds. This classification is carried out at the same periodic cycle as the periodic cycle R of updating the time-series data record (i.e., every 0.02 seconds).

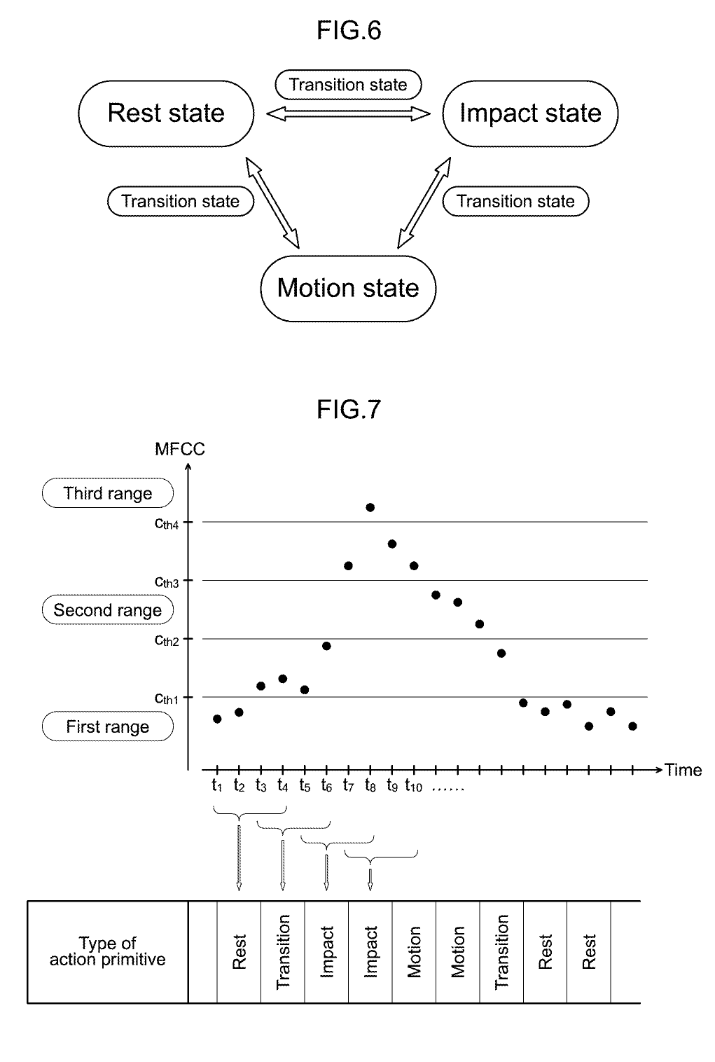

As described above, the primitive classifier 4 classifies an action of a minute time into one of the four action primitives (rest state, motion state, impact state, and transition state). As illustrated in FIG. 6, the transition state is a state not classified into any of the above remaining three states and can be regarded as an intermediate state of the above three states. The rest state, the motion state, and the impact state shift into other states via the transition state. For example, the rest state does not directly shift into the motion state, but does shift through the transition state first and then into the motion state, and vice versa. In relation to the impact state, it may be assumed that an actual rate of an action has a possibility that the rest state directly shifts into the impact state or any actual rate of an action has no possibility of such a direct shift.

The primitive classifier 4 determines the type of action primitive on the basis of the four values of the MFCC primary component c₁ included in the time-series data record. Here, the following three ranges are defined using four thresholds c_{TH1}, c_{TH2}, c_{TH3}, and c_{TH4} of an arbitrary MFCC primary component c. There thresholds have relationship c_{TH1}<c_{TH2}<c_{TH3}<c_{TH4}, and examples of the values of these thresholds are c_{TH1}=−10, c_{TH2}=−7, c_{TH3}=−3, and c_{TH4}=0.

first range: a range equal to or lower than c_{TH1} (c≦c_{TH1})

second range: a range equal to or higher than c_{TH2} and also equal to or lower than c_{TH3} (c_{TH2}≦c≦c_{TH3})

third range: a range equal to or higher than c_{TH4} (c≧c_{TH4})

When at least one of the four values of the MFCC primary component c₁ (serving as a single set of time-series data record) is within the first range and none of the four values is within the second and the third ranges, the primitive classifier 4 classifies the action primitive corresponding to the time-series data record into the “rest state”. When at least one of the four values of the MFCC primary component c₁ is within the second range and none of the four values are within the first and the third ranges, the primitive classifier 4 classifies the action primitive corresponding to the time-series data record into the “motion state”.

When at least one of the four values of the MFCC primary component c₁ is within the third range and none of the four values are within the first and the second ranges, the primitive classifier 4 classifies the action primitive corresponding to the time-series data record into the “impact state”. When the four values of the MFCC primary component c₁ do not satisfy any of the above three cases, the primitive classifier 4 classifies the action primitive corresponding to the time-series data record into the “transition state”. For example, when all the four values of the MFCC primary component c₁ are not within any of the first to the third ranges and when the four components are distributed in two or more of the above ranges, the action primitive of the corresponding time-series data record is classified to the “transition state”.

An example of the relationship between the values of an MFCC primary component c₁ and the type of the corresponding action primitive is depicted in FIG. 7. MFCC primary components c₁ are calculated every 0.01 seconds from the time t₁ by the cepstrum extractor 2 and then stored into the first buffer 3. The primitive classifier 4 classifies an action primitive on the basis of a set of such four values of the MFCC primary component c₁ and this classification is repeated every 0.02 seconds.

For example, among the values of MFCC primary component c₁ at the times t₁-t₄, two values are within the first range and the remaining two are not within the second and the third range. Consequently, the action primitive corresponding to this time-series data record is the “rest state”. Since the values of MFCC primary component c₁ at the times t₃-t₆ are not within any of the first to the third ranges, the corresponding action primitive is the “transition state”. Since one of the values of MFCC primary component c₁ at the ensuing times t₅-t₈ is within the third range, the corresponding action primitive is the “impact state”.

As the above example, the primitive classifier 4 determines a state matching the multiple values of the cepstrum coefficient included in a time-series data record and classifies (labels) the type of action primitive. Labeling the type of action primitive represents the feature of body-conducted sound of each minute time and corresponds to a phoneme that is used in voice identification technology. The information of the type of action primitive classified here is sent to the second buffer 7 at the periodic cycle R of updating.

The four types of action primitive are broadly classified into the “rest state” and the “non-rest state”. The “non-rest state” includes the “motion state”, the “impact state”, and the “transition state”. Defining at least the first range is satisfactory to discriminate the “rest state” from the “non-rest” state. For example, when at least one of the four values of the MFCC primary component c₁ is within the first range, the action primitive corresponding to the time-series data record is classified into the “rest state”. In contrast, the four values of the component are all without the first range, the corresponding action primitive is classified into the “non-rest state”. This classification can recognize at least the time points of the start and the end of an action.

4-5. Inclination Calculator

As illustrated in FIG. 3, the inclination calculator 5 is disposed in parallel with the primitive classifier 4 with respect to the flow of data from the first buffer 3. This configuration allows the primitive classifier 4 and the inclination calculator 5 to execute calculation in parallel with each other using the same time-series data record provided from the first buffer 3.

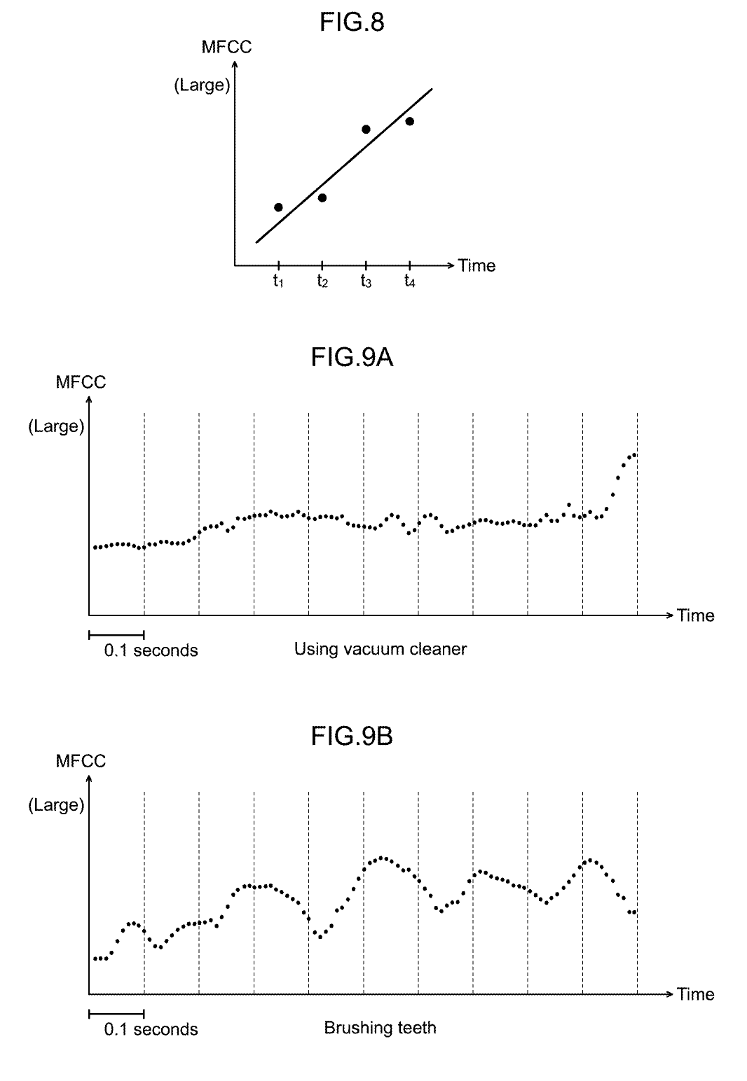

The inclination calculator 5 (gradient calculator) calculates the inclination (slope, gradient per unit of time) of chronological change of an MFCC primary component c₁ for a minute time corresponding to a time-series data record stored in the first buffer 3, using the time-series data record. As illustrated in FIG. 8, the inclination calculator 5 of this embodiment calculates the inclination of a line obtained by approximating the distribution (tendency of gradient per unit of time) of the data points of the MFCC primary component c₁ included in a time-series data record of the minute time to a straight line.

As one of specific calculation manners, a regression line of the MFCC primary component c₁ is obtained by, for example, method of least square or principal component analysis, and the inclination of the regression line is calculated. The inclination calculated by the inclination calculator 5 is sent to the second buffer 7 at the periodic cycle R of updating. Since the information of the inclination calculated in the inclination calculator 5 is to be used as an input parameter into a probability model to estimate an action in the action estimator 9 that is to be detailed below, the inclination is preferable calculated in the radian unit. The radian unit can describe the limit value of an inclination in a finite value, and is preferably used to suppress overflow in calculation at the computer 12.

The absolute value of the gradient per unit of time of the MFCC primary component c₁ tends to increase when the state of an action more steeply changes. An action of a limb has a large gradient change when the action is made under a state where the wrist or the ankle is fixed to some degree. Such a gradient change is observed in, for example, an action that generates a low-frequency change in amplitude. Accordingly, the information of the inclination is one of indexes to determine an action of the limb.

Examples of graphs in which data points of MFCC primary components c₁ corresponding to respective different actions are plotted are denoted in FIGS. 9A and 9B. FIG. 9A is a graph related to an action of a hand when the wearer cleans the floor using a vacuum cleaner; and FIG. 9B is a graph related to an action of a hand when the wearer brushing the teeth. Both actions are actions that move the arm, which is relatively heavy in weight, and tend to generate a low-frequency change in amplitude. However, since these actions are made under different stable state of the hand, the gradient changes of these actions behave differently from each other.

As depicted in FIG. 9A, the values of the MFCC primary component c₁ of the former example have relatively small fluctuation and result in small gradient change. It seems that this is because the vacuum cleaner is positioned on the ground (floor) when being used and the action of the hand is a stable motion. In contrast, as depicted in FIG. 9B, the values of the MFCC primary component c₁ of the latter example have relatively large fluctuation and result in large gradient change. It seems that this is because the hand is moving in the air when brushing teeth and the action of the hand is an unstable motion.

4-6. Square Error Calculator

As illustrated in FIG. 3, the square error calculator 6 (dispersion calculator) is disposed immediately downstream (in series) of the inclination calculator 5 along the flow of data from the first buffer 3. The square error calculator 6 calculates the extent of the dispersion (variation) of values of the MFCC primary component c₁ of a minute time corresponding to a time-series data record. Specifically, the square error calculator 6 of this embodiment calculates the extent of the dispersion of the data points of the MFCC primary component c₁ from the regression line obtained during the course of the calculation in the inclination calculator 5.

In this embodiment, the sum of square errors of the regression line (the linear graph of FIG. 8) and individual data points are calculated to be the extent of the dispersion of the corresponding time-series data record. The information of the extent of the dispersion calculated in the square error calculator 6 is sent to the second buffer 7 at the periodic cycle R of updating and is to be used as an input parameter to a probability model to estimate an action in the action estimator 9.

The extent of the dispersion tends to be larger when the corresponding action is less stable. An action of a limb increases the extent of the dispersion when the action is made under a state where the wrist or ankle is not fixed much (an action accompanies rotation of the fingertip or the tip of the toe). Such a change in extent of the dispersion is observed in an action that generates, for example, a high-frequency change in amplitude. Accordingly, the information of the extent of the dispersion is one of indexes to determine an action of the limb.

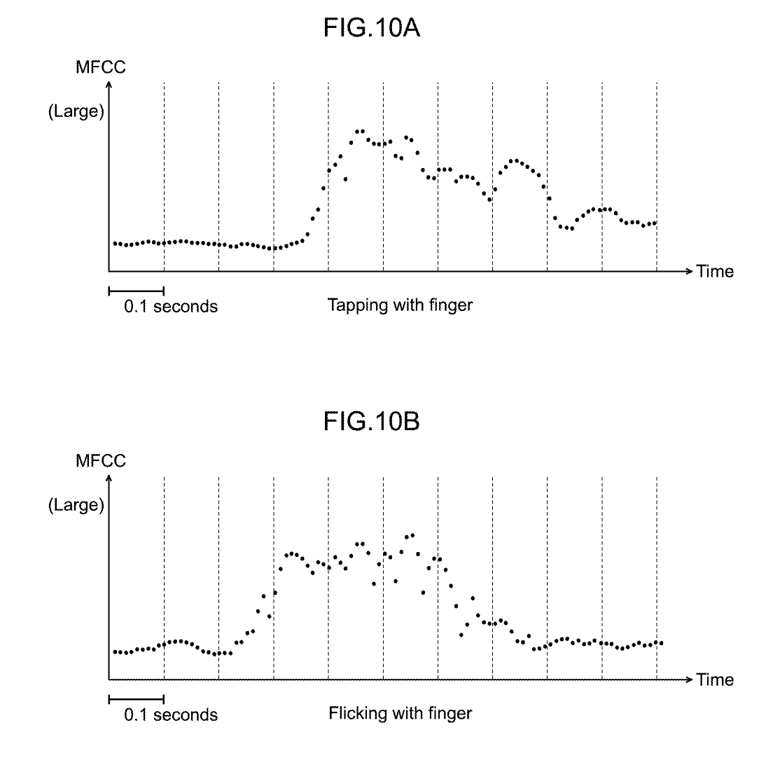

FIG. 10A is a graph in which data points of the MFCC primary component c₁ corresponding to an action of tapping with a finger are plotted while FIG. 10B is a graph in which data points of the MFCC primary component c₁ corresponding to an action of flicking (wagging) with a finger (the first finger) are plotted. Both actions are actions that move a finger or the wrist, which is relatively light in weight, and tend to generate a high-frequency change in amplitude. However, since these actions are different in direction and facility of the motion, the extents of dispersion of these actions are different from each other.

As depicted in FIG. 10A, the values of the MFCC primary component c₁ of the former example have relatively small variation and result in small extent of the dispersion. It seems that this is because tapping is an action along the orientation of the muscular fiber of the finger and is a stable action. In contrast, as depicted in FIG. 10B, the values of the MFCC primary component c₁ of the latter example have large variation and result in large extent of the dispersion. It seems that this is because flicking in the lateral direction is an action incapable of fixing the wrist and is an unstable action.

4-7. Second Buffer

The second buffer 7 contains various pieces of information of the type of action primitive, the values, the inclination, and the extent of the dispersion of the MFCC obtained by the primitive classifier 4, the inclination calculator 5, and the square error calculator 6. In this example, the three kinds of information obtained from a single time-series data record is stored as a single data set in the time-series manner in combination with the corresponding values of MFCCs. If the cepstrum extractor 2 extracts multiple cepstrum coefficients, the data set for each of the cepstrum coefficients are likewise stored.

The periodic cycle S of increasing the number of data sets in the second buffer 7 is the same as the periodic cycle R of updating the time-series data record in the first buffer 3. The updating periodic cycle R of this embodiment is 0.02 seconds and therefore the information of a type of action primitive, an inclination, and an extent of the dispersion is calculated every 0.02 seconds. Consequently, the number of time-series data records increases every 0.02 seconds.

The second buffer 7 has a capacity affordable to store at least three data sets. In other words, in the second buffer 7, information of types of action primitive, values of MFCCs, inclinations, and extents of dispersion obtained from three sets of time-series data records is stored. Alternatively, the number of data sets to be stored in the second buffer 7 may be modified in accordance with the ample storage capacity. The three data sets stored in the second buffer 7 are sent to the primitive classification corrector 8.

After that, the second buffer 7 stores new data set in, for example, the FIFO manner, and discards storing data sets from the oldest as much as the overflow from its capacity, so that the combination of data sets in second buffer 7 is always updated. Each time the combination of data sets is updated, the three data sets are transmitted to the primitive classification corrector 8, where the alignment of the types of action primitive is determined.

4-8. Primitive Classification Corrector

The primitive classification corrector 8 (reclassifier) corrects the types of action primitive contained in the three data sets sent from the second buffer 7. Specifically, the correction of the types of action primitives is based on the alignment of the types. For example, in cases where, among three types Y₁, Y₂, and Y₃ of action primitives aligned in the time-series order, all the types Y₁-Y₃ are not in the “transition state” or “impact state” and the types Y₁ and Y₃ are in the same state, the type Y₂ is corrected (reclassified) to the same state as that of the type Y₁. Specifically, the type Y₂ is corrected in the following alignments of action primitive.

### Example 1

Y₁: “rest state”→Y₂: “motion state”→Y₃: “rest state”

### Example 2

Y₁: “motion state”→Y₂: “rest state”→Y₃: “motion state”

These alignments are corrected as follows.

### Example 1

Y₁: “rest state”→Y₂: “rest state”→Y₃: “rest state”

### Example 2

Y₁: “motion state”→Y₂: “motion state”→Y₃: “motion state”

Alternatively, in cases where none of the types Y₁-Y₃ is in the “transition state”, the types Y₁ and Y₃ are in the same state and do not change between the “motion state” and the “impact state”, the type Y₂ may be corrected to the same state as that of the type Y₁. In this alternative, the type Y₂ is corrected in the following alignments in addition to the above Examples 1 and 2.

### Example 3

Y₁: “rest state”→Y₂: “impact state”→Y₃: “rest state”

### Example 4

Y₁: “impact state”→Y₂: “rest state”→Y₃: “impact state”

These alignments are corrected as follows.

### Example 3

Y₁: “rest state”→Y₂: “rest state”→Y₃: “rest state”

### Example 4

Y₁: “impact state”→Y₂: “impact state”→Y₃: “impact state”

The above are correction for erroneous determination of the type of action primitive, considering the motion capability of the limb. The minute time for classification in the primitive classifier 4 is satisfactorily short as compared with the precision of an action and there is a low possibility of alternating different types of action primitive. A different type of action primitive sandwiched between the same type of action primitive is not in the “transition state”, the primitive classification corrector 8 regards the different sandwiched type as erroneous determination and then corrects the different type of action primitive to the same type as of the prior and the subsequent action primitive. The data set in which the type of action primitive has been corrected is sent to the action estimator 9.

4-9. Action Estimator

The action estimator 9 estimates an action corresponding to the body-conducted sound on the basis of the information (i.e., the action feature amount) obtained by the action feature amount extractor 1. Into the action estimator 9, data sets each including types of action primitive corrected in the primitive classification corrector 8 are input in the time-series order. The action estimator 9 has the following three functions. The first functions is an “extracting function” that extracts information related to an action of a limb from the data sets sent from the primitive classification corrector 8. The second function is a “determining function” that determines the action on the basis of the extracted information. The third function is a “learning function” that corrects a model to be used in the determination on the basis of the extracted information.

The “extraction function” is controlled on the basis of the type of action primitive included in data sets. For example, the time at which the type of action primitive is changed from the “rest state” to another state is determined to be the time of the start of the action and extracting of information is started. In contrast, the time at which the type of action primitive is changed from a state except for the rest state to the “rest state” is determined to be the time of the end of the action and the extracting of information is finished. The data sets used for this determination have been corrected by the primitive classification corrector 8. Accordingly, fluctuation of the action primitive between the start and the end of the action (due to erroneous determination) has already been suppressed, so that information at suitable timings can be extracted.

The “determining function” is executed on the information extracted by the extracting function. For example, probability models are prepared in the action estimator 9 for each type of action to be determined. The action estimator 9 estimates an action represented by the extracted information, using the prepared probability models. An example of a probability model used by the action estimator 9 is an HMM (Hidden Markov Model) that represents a modeled pattern of fluctuation in action primitive, or an RNN (Recurrent Neural Network) that represents a modeled pattern of an action by means of neural elements having non-monotonic output characteristics.

An HMM is one of probability state transition models to calculate a likelihood that is a degree of the coincidence of the input information with the model. An HMM sets multiple states that fluctuate in time series and sets a probability of state transition for each combination of states. In an HMM the state of a certain time point is determined, depending on the state before the time (e.g., the state of immediately before the certain time points). The respective states are not directly observed, but a symbol randomly output in each state is observed.

When HMMs have already been obtained through previous learning, a probability pᵢⱼ(x) of transition from a state Sᵢ to a state Sⱼ is set for an input x in each HMM. An identifier that returns an output symbol at a probability qⱼ(x) to each state Sⱼ is provided in the action estimator 9. The action estimator 9 provides an input xₜ of the data set that has been undergone the correction in the primitive classification corrector 8 to each HMM and calculates the likelihood Πpᵢⱼ(xₜ)qⱼ(x) of the input xₜ. Then, the action estimator 9 outputs an action corresponding to the probability model that provides the maximum likelihood as the result of the estimating. This means that an action that has the maximum probability of obtaining the input time-series data set is estimated to be an actual action corresponding to the body-conducted sound data. The information obtained in the action estimator 9 is output to the output device 15 via the interface 24 and is used as, for example, a signal to operate the output device 15.

In the manner of using HMMs obtained by previous learning, the designer sets the number of states regarded as models. The initial values of learning parameters are preferably set so as not to converge on a local solution. Examples of a parameter corresponding to an input xₜ into an HMM are a type of action primitive, an inclination of a cepstrum coefficient, and the sum of square errors. Alternatively, a discrete value may be set for each type of action primitive and used for an input parameter.

When an action primitive is used as an input into each HMM, the state of an action primitive corresponding to an action of a certain time series can be divided into any number. The position of dividing under the optimum state is searched through the estimation in the action estimator 9 and the optimum transition probability pᵢⱼ(x) and the optimum state probability qᵢⱼ(x) are also searched.

The “learning function” is a function of correcting and learning the determined action model used in the determining function on the basis of the information extracted by the “extracting function”. The above HMMs can be obtained and updated through learning with the information (action feature amount) obtained by the action feature amount extractor 1. For example, a type of action primitive conforms to a state Sᵢ of each HMM. Here, the state Sᵢ corresponds to one of the motion state, the impact state, and the transition state. Each state Sᵢ is assumed to output a symbol in conformity with an output probability distribution (e.g., a normal distribution or multinomial distribution) defined for the state. The above action feature amount is used as a parameter to determine the output probability distribution.

Specifically, the number of states Sᵢ of each HMM is set to be the same as the number of types of action primitive and the point at which an action primitive changes is provided as a point where the state Sᵢ is changed into the state Sⱼ. This allows a model representing the probability qⱼ(x) of being state Sᵢ to be derived from the inclination of any action primitive or the sum of square errors. Simply optimizing the transition probability pᵢⱼ(x) from the state Sᵢ to the state Sⱼ can generate an HMM. Furthermore, the model generated in the above manner is relearned, releasing the fixation of the transition point from the state Sᵢ to the state Sⱼ, can avoid convergence on a local solution. Consequently, the learning function can correct the thresholds c_{TH1}, c_{TH2}, c_{TH3}, and c_{TH4} that are used when the primitive classifier 4 classifies an action primitive.

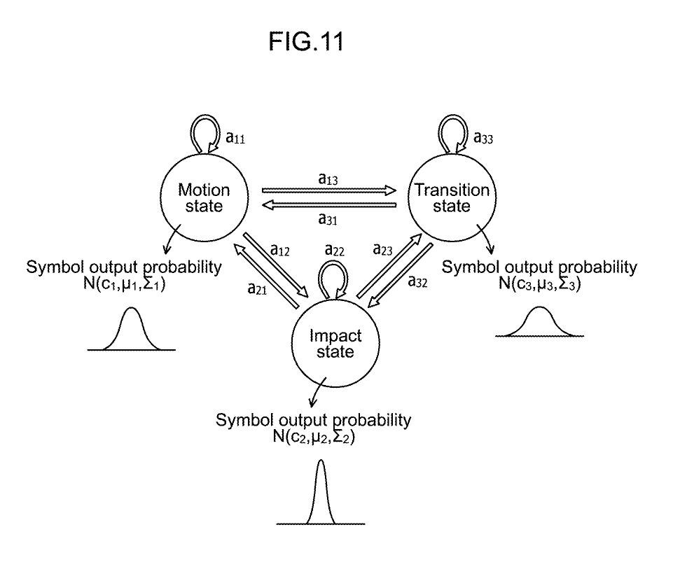

FIG. 11 illustrates an example of an HMM related to learning a model in the “learning function” of this embodiment. In FIG. 11, each of the motion state, the impact state, and the transition state is applied to the state Sⱼ of the HMM. Each state Sⱼ here is assumed to output an output symbol in obedience to a normal distribution dedicated to the state Sⱼ when the state Sⱼ is shifted from another state. The symbol aᵢⱼ in FIG. 11 represents a state transition probability from the state Sᵢ to the state Sⱼ. The probability N(c,μ,Σ) of outputting a symbol at each state Sⱼ is regarded as a function based on at least one of the values (primary components c₁ to n-th component cₙ), the inclination μ, an extent of the dispersion (sum Σ of square errors).

The action estimator 9 searches for a route having the maximum sum (likelihood) of aᵢⱼ·N(c,μ,Σ) with respect to an input xₜ of the time-series data set having undergone the correction in the primitive classification corrector 8 by providing the input xₜ into each HMM. Then, the action estimator 9 outputs the action corresponding to the route having the maximum likelihood as the result of the estimating.

When an action primitive is used as the state Sⱼ of each HMM, the state of the action primitive corresponding to an action of a certain time series is divided into a number determined by the alignment of the types of action primitive obtained in the action feature amount extractor 1 and the position of the division is also determined. Through the estimating in the action estimator 9, the transition probability pᵢⱼ(x) of the optimum state is searched and a state probability qᵢⱼ(x) can be generated.

5. Flow Diagram

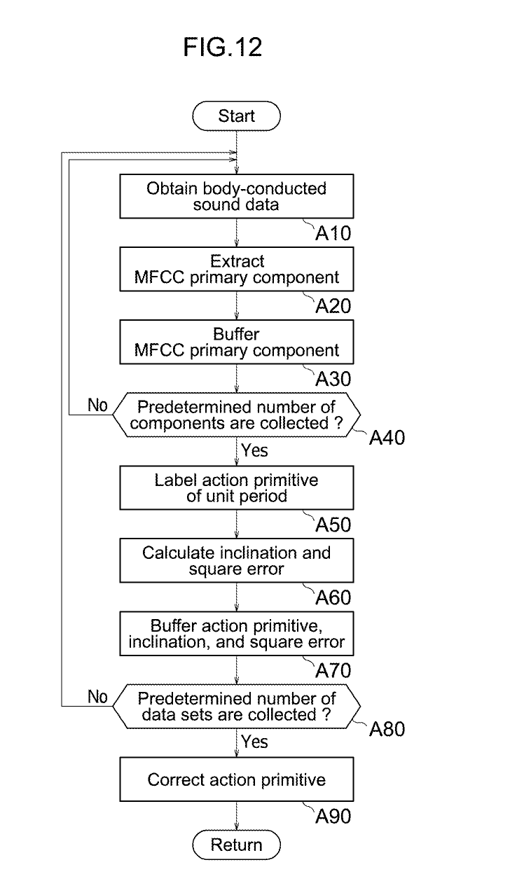

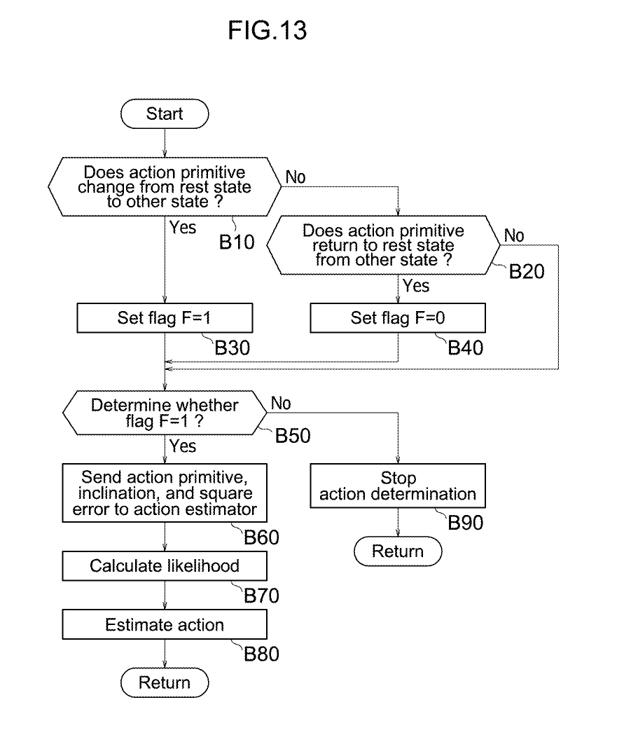

FIGS. 12 and 13 are flow diagrams denoting successions of procedural steps of a method of detecting an action applied to the action detector 10. These flows correspond to procedure of control performed by an application program stored in, for example, the auxiliary memory 23 or a removable medium and read into the computer 12, which repeatedly executes the program at a predetermined cycle. The cycle of executing the program is assumed to be, for example, equal to or less than the periodic cycle P (0.01 seconds) of calculating an MFCC primary component c₁ in the cepstrum extractor 2.

5-1. Extracting an Action Feature Amount

The flow diagram of FIG. 12 corresponds to the control mainly performed in the action feature amount extractor 1. In step A10, body-conducted sound data is input into the computer 12. If real-time determination of an action is carried out in the action detector 10, body-conducted sound data measured by the body-conducted sound microphone 11 is immediately input into the computer 12. In contrast, if the action detector 10 uses body-conducted sound data obtained beforehand, the body-conducted sound data may be recorded in a removable medium and then read by the storage reader/writer 13. The body-conducted sound data input in this step is sent to the cepstrum extractor 2 of the action feature amount extractor 1.

In step A20, a cepstrum coefficient of the body-conducted sound is extracted as time-series data. In this step, an MFCC primary component c₁ is calculated from the body-conducted sound data of, for example, 0.1 seconds. Specifically, the cepstrum extractor 2 calculates the MFCC primary component c₁ by substituting 1 for the variable n in the above Expression 2 (n=1) and also substituting the product of the logarithm spectrum and the Mel filter bank (the j-th band) for the variable mⱼ of the Expression 2. The value of the MFCC primary component c₁ obtained in this step is sent to the first buffer 3.

In step A30, the value of the MFCC primary component c₁ calculated by the cepstrum extractor 2 is stored (buffered) into the first buffer 3. In the ensuing step A40, a determination is made as to whether the number of MFCC primary components c₁ stored in the first buffer 3 reaches a predetermined number. For example, if the number of stored MFCC primary components c₁ is less than four, the data amount is below that of a set of a time-series data record and the control proceeds to step A10 to extract a cepstrum coefficient again. If four MFCC primary components c₁ are collected in the first buffer 3, the four MFCC primary components c₁ are regarded as a set of time-series data set, which is then sent to the primitive classifier 4 and the inclination calculator 5. The feature of the action of the minute time (e.g., 0.04 seconds) is reflected in the time-series data record.

In step A50, the primitive classifier 4 labels the types of action primitive in accordance with the time-series data records, so that the type of action for a minute time is determined. In this step, on the basis of the values of the four MFCC primary components c₁ included in the same time-series data record, the type of action primitive is classified into, for example, the “rest state”, the “motion state”, the “impact state”, and the “transition state”. As more facilitating classification, the types of action primitive may be classified into the “rest state” and the “non-rest state”. Here, the information about the type of action primitive classified in this step is sent to the second buffer 7.

In step A60, the inclination calculator 5 calculates the gradient per unit of time of the MFCC primary component c₁ of the minute time, which corresponds to the time-series data record, while the square error calculator 6 calculates an extent of the dispersion of the MFCC primary component c₁. In these parameters calculated in this step, the extent of steepness of the action and the stability of the action are reflected. The information of the gradient and the extent of the dispersion calculated in this step is transmitted to the second buffer 7.

In step A70, information of the types of action primitive, the inclination, and the extent of the dispersion obtained in steps A50 and 60 is stored into the second buffer 7. These three kinds of information is stored (buffered) as a single data set in the time-series order and is to be used as an input parameter of a probability model for estimating the action. In the next step A80, a determination is made as to whether the number of data sets stored in the second buffer 7 reaches a predetermined number. For example, when the number of data sets is less than three, the process proceeds to step A10 to generate a data set again. When three data sets are collected in the second buffer 7, the collected data sets are sent to the primitive classification corrector 8.

In step A90, the primitive classification corrector 8 corrects (reclassifies) the types of action primitive included in the received three data sets. Specifically, the primitive classification corrector 8 reclassifies the type of action primitive positioned in the middle of the time-series alignment. For example, if the rest state and the motion state are alternately aligned, the state positioned in the middle in the time-series alignment is erroneously classified and corrected into the same state as that of the prior and subsequent type of action. The corrected data sets are sent to the action estimator 9.

In this flow, the above control is repeated and finally outputs data sets each including information representing a type of action primitive, an inclination, and an extent of the dispersion to the action estimator 9. The time-series data record of this embodiment is updated each time two MFCC primary components c₁ are output (i.e., at the periodic cycle of 0.02 seconds). Likewise, since a data set is generated each time the time-series data record is updated, the data set is generated every 0.02 seconds.

Each data set contains information overlapping with information of the time-series prior and subsequent data sets. The information not overlapping with information of another data set is information of a single data record positioned in the time-series back end. Accordingly, new information is sent to the action estimator 9 every 0.02 seconds. In some alignment of types of action primitive contained in the time-series data records, the information of the immediately prior data set may be corrected using the information contained in the immediately subsequent data set. For example, information overlapping with information in another data set can be corrected using a data set newly added. Accordingly, information in the data set is fixed when the data set does not overlap with another data set newly added any longer.

5-2. Extracting and Estimating an Action

The flow diagram of FIG. 13 corresponds to the control mainly performed in the action estimator 9.

In step B10, the information of the types of action primitive each contained in a data set is confirmed in the time-series order and a determination is made as to whether the type of action primitive is changed from the “rest state” to another state. If this condition is satisfied, the control proceeds to step B20, where the value of the flag F is set to be F=1, and then proceeds to step B50. The flag F serves as a control register that holds a value (information to determine whether information is to be extracted) representing the presence or the absence of a possibility of an action; the value F=1 represents that an action is being made and the value F=0 represents that an action is not being made.

If the condition of step B10 is not satisfied, the control proceeds to step B30, where a determination is made as to whether the type of action primitive is changed from a state except for the rest state into the rest state. If this condition of step B30 is satisfied, the control proceeds to step B40, where the value of the flag is set to be F=0, and then proceeds to step B50. If the condition of step B30 is not satisfied, the value of the flag F is not changed and the control proceeds to step B50.

In step B50, whether the value of the flag F is F=1 is determined. If F=1 is satisfied, the control proceeds to step B60 to start the determination of an action. First of all, the data sets sent to the action estimator 9 are further sent to an HMM. In step B70, the likelihood of the input information is calculated in conformity with the HMM. In the ensuing step B80, an action corresponding to the identifier having the maximum likelihood is estimated as an action corresponding to the body-conducted sound data.

The above estimation calculation is repeated until the value of the flag F comes to be F=0. For example, when the type of action primitive contained in a data set is changed into the “rest state”, the value of the flag F is set to be F=0 in step B40 and the control proceeds through step B50 to step B90. In step B90, the input of a data set into the HMM is shut and determination of the action is also stopped. When the type of action primitive comes to be a state except for the rest state again, the value of the flag F is set to be F=1 to restart the determination of the action.

6. Result

6-1. Classifying an Action Primitive

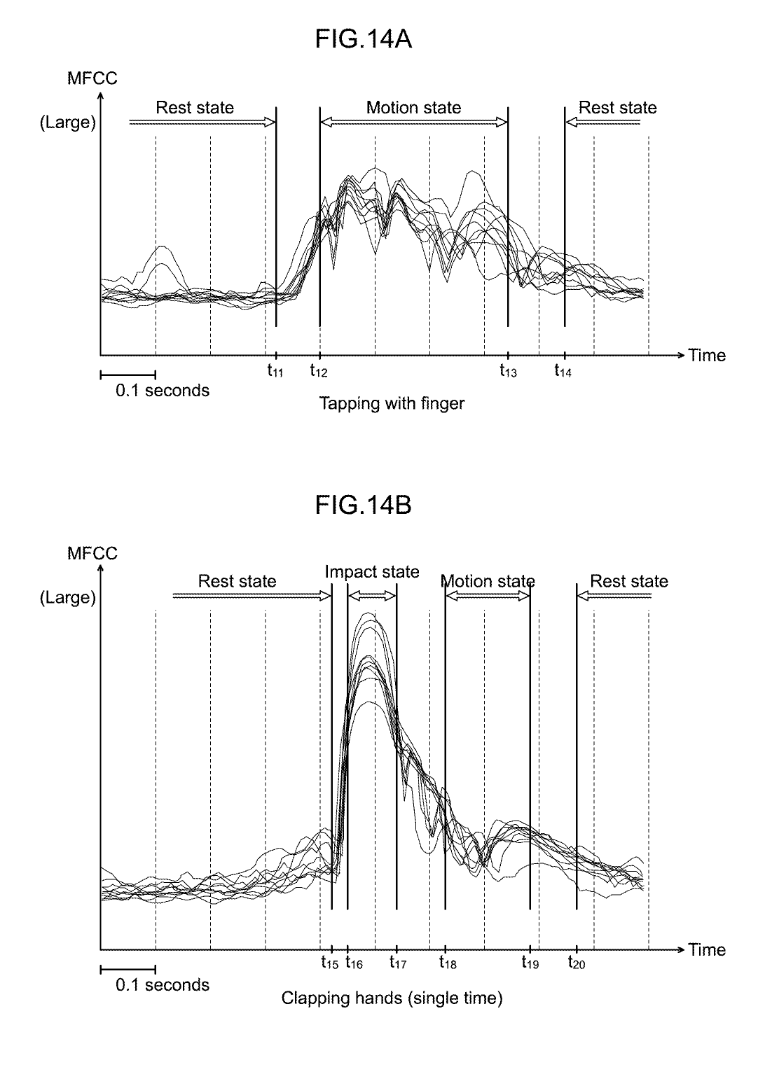

FIG. 14A is a graph depicting a chronological change of an MFCC primary component c₁ obtained from body-conducted sound generated by an action of a finger; and FIG. 14B is a graph depicting a chronological change of an MFCC primary component c₁ obtained from body-conducted sound generated by clapping hands. In each drawing, the time-series data of an MFCC primary component c₁ corresponding to a single-time action is expressed by a single line graph and the data of an action made ten times is superimposed on the graph.

The time t₁₁ in FIG. 14A is a time point at which the action primitive classified on the basis of the MFCC primary component c₁ corresponding to the first tapping action with a finger is changed from the “rest state” to the “transition state”. Likewise, the times t₁₂, t₁₃, and t₁₄ are a time point of changing from the “transition state” to the “motion state”, a time point of changing from the “motion state” to the “transition state”, and a time point of changing from the “transition state” to the “rest state”, respectively. The graph FIG. 14A indicates that the gradients per unit time of MFCC primary components c₁ of the same actions may have the similar tendency of fluctuation.

Likewise, times t₁₅-t₂₀ of FIG. 14B corresponds to the boundary between the “transition state” to another state. This graph of FIG. 14B indicates that the value of the MFCC primary component c₁ has a tendency of steeply increasing at the portion corresponding to an action that generates an impact and fluctuating, at the subsequent portion of the action, at slightly larger value than that in the rest state.

6-2. Estimating an Action

The following Table 1 denotes test results of determining an action of a fingertip by the action detector 10. The Table 1 denotes the relationship between the percentages of successfully determining each of the actions of flexion, extension, palmar flexion, dorsal flexion, pronation, and supination and parameter(s) used for the determination by the action estimator 9. In this example, each HMM was learned using 20 tries of the actions, and the action is determined on the basis of HMMs using data of 30 tries for each action.

The results of a test of the first row of Table 1 is a determination percentage when the probability distribution of each output symbol of an HMM is set on the basis of the inclination of the cepstrum coefficient (MFCC primary component) and the extent of the dispersion of the cepstrum coefficient (sum of the square errors). The result of the second row of Table 1 is a determination percentage when probability distribution of each output symbol of an HMM was set further using the value of the MFCC primary component c₁ in addition to the determination of the first row. The determination of the third and fourth rows further used the MFCC secondary component in addition to the determination of the second row, and the determination of the fifth and six rows further used the MFCC tertiary component in addition to the determination of the third and fourth rows.

As denoted in Table 1, in determination using the inclination of the cepstrum coefficient and the extent of the dispersion of the cepstrum coefficient, the determination percentage increases as the MFCC component that is used in combination is higher order. However, some actions (e.g., palmar flexion and supination) can expect preferable determination percentages when a higher-order MFCC coefficients are not used. Accordingly, the number and the type of parameter to be used may be determined on the basis of the type of action to be determined.

TABLE 1

| | | | Palmar | Dorsal | | | |
|---|---|---|---|---|---|---|---|
| | Flexion | Extension | Flexion | Flexion | Pronation | Supination | Average |
| Only MFCC | 70.0% | 10.0% | 16.6% | 10.0% | 0% | 86.6% | 32.2% |
| primary | | | | | | | |
| component, | | | | | | | |
| inclination, | | | | | | | |
| sum of square | | | | | | | |
| errors | | | | | | | |
| Only MFCC | 76.6% | 73.3% | 83.3% | 43.3% | 30.0% | 60.0% | 61.1% |
| primary | | | | | | | |
| component, | | | | | | | |
| value, | | | | | | | |
| inclination, | | | | | | | |
| sum of square | | | | | | | |
| errors | | | | | | | |
| MFCC primary | 90.0% | 16.6% | 70.0% | 80.0% | 40.0% | 50.0% | 57.7% |
| and secondary | | | | | | | |
| components, | | | | | | | |
| inclination, | | | | | | | |
| sum of square | | | | | | | |
| errors | | | | | | | |
| MFCC primary | 100% | 60.0% | 63.3% | 80.0% | 83.3% | 96.9% | 80.5% |
| and secondary | | | | | | | |
| components, | | | | | | | |
| value, | | | | | | | |
| inclination, | | | | | | | |
| sum of square | | | | | | | |
| errors | | | | | | | |
| MFCC primary, | 93.3% | 13.3% | 70.0% | 63.3% | 56.6% | 40.0% | 56.1% |
| secondary, | | | | | | | |
| tertiary | | | | | | | |
| components, | | | | | | | |
| inclination, | | | | | | | |
| sum of square | | | | | | | |
| errors | | | | | | | |
| MFCC primary, | 100% | 73.3% | 63.3% | 83.3% | 86.6% | 86.6% | 82.2% |
| secondary, | | | | | | | |
| tertiary | | | | | | | |
| components, | | | | | | | |
| value, | | | | | | | |
| inclination, | | | | | | | |
| sum of square | | | | | | | |
| errors | | | | | | | |

Table 2 indicates a determination percentage on the basis of only the value of a cepstrum coefficient not using the inclination and the extent of the dispersion of the cepstrum coefficient. The number of data pieces used for learning each HMM and the number of data pieces used for determining an action were the same as those of the determination test of Table 1. The results of the first row correspond to a case where the probability distribution for each output symbol of an HMM is set using only the MFCC primary component c₁. The results of the second row correspond to a case where the probability distribution for each output symbol of an HMM is set using an MFCC secondary component c₂ in addition to the MFCC primary component c₁ of the first row. The subsequent third to eighth rows are results obtained by using MFCC components, whose orders were increased in increment of one from the tertiary to octonary components.

As denoted in Table 2, the determination percentage of a fingertip action improves with the combination use of the MFCC primary component c₁ and the MFCC secondary component c₂ as compared with the case solely using the MFCC primary component c₁. Using more higher-order components more increases the determination percentage. Using the MFCC primary component c₁ through the MFCC senary component c₆ can obtain the determination percentage over 80% for all the actions in the Table. Using even only the MFCC primary component c₁ can expect the determination percentages over 70% for the extension action, the palmer flexion action, and the supination action. Accordingly, the order of the cepstrum coefficient to be used may satisfactorily be determined depending on an action to be determined.

TABLE 2

| | | | Palmar | Dorsal | | | |
|---|---|---|---|---|---|---|---|
| | Flexion | Extension | Flexion | Flexion | Pronation | Supination | Average |
| Only MFCC | 20.0% | 70.0% | 76.6% | 40.0% | 0% | 76.6% | 47.2% |
| primary | | | | | | | |
| component | | | | | | | |
| Only MFCC | 100% | 73.3% | 23.3% | 66.6% | 80.0% | 96.6% | 68.3% |
| primary and | | | | | | | |
| secondary | | | | | | | |
| components | | | | | | | |
| Only MFCC | 100% | 83.3% | 43.3% | 83.3% | 93.3% | 96.6% | 83.3% |
| primary to | | | | | | | |
| tertiary | | | | | | | |
| components | | | | | | | |
| Only MFCC | 100% | 83.3% | 36.6% | 83.3% | 100% | 96.6% | 83.3% |
| primary to | | | | | | | |
| quaternary | | | | | | | |
| components | | | | | | | |
| Only MFCC | 100% | 90.0% | 66.6% | 90.0% | 96.6% | 100% | 90.5% |
| primary to | | | | | | | |
| quinary | | | | | | | |
| components | | | | | | | |
| Only MFCC | 100% | 96.6% | 80.0% | 86.6% | 100% | 100% | 93.8% |
| primary to | | | | | | | |
| senary | | | | | | | |
| components | | | | | | | |
| Only MFCC | 96.6% | 93.3% | 80.0% | 86.6% | 100% | 96.6% | 92.2% |
| primary to | | | | | | | |
| septenary | | | | | | | |
| components | | | | | | | |
| Only MFCC | 100% | 93.3% | 90.0% | 93.3% | 100% | 96.6% | 95.5% |
| primary to | | | | | | | |
| octonary | | | | | | | |
| components | | | | | | | |

7. Effects

(1) The above action detector 10, a method for detecting an action performed by the action detector 10, and a program for detecting an action executed by the action detector 10 extract, as time-series data, a cepstrum coefficient generated by an action of a limb by the cepstrum extractor 2. The first buffer 3 generates time-division data by time-dividing the time-series data. The primitive classifier 4 classifies a type of action primitive corresponding to each time-division data on the basis of the cepstrum coefficient included in the time-division data.

The classification of types of action primitive based on time-division data of the time-series data of the cepstrum coefficient can precisely estimate and grasp a change in action, such as the start and the end of an action. This can enhance the precision in detecting an action of a limb, so that the robustness of action determination can be improved.

(2) The cepstrum extractor 2 extracts at least a primary component (MFCC primary component c₁) of the cepstrum coefficient. This enables the action detector 10 to precisely grasp the feature of a low-frequency component of the vibration spectrum of an action. In other words, since action primitives are classified on the basis of the feature of a low-frequency component, which is less attenuated among the vibration generated by the action of the limb, the precision in detecting an action can be enhanced.

(3) The primitive classifier 4 classifies action primitives into the “rest state”, the “motion state”, the “impact state”, and the “transition state”. This classification allows the action detector 10 to precisely grasp a transition state from the rest state to the impact state. For example, an ambiguous state corresponding to neither the rest state nor the motion state can be classified into the transition state, so that the precision in detecting an action can be enhanced.

(4) The four types of action primitive are broadly classified into the “rest state” and the “non-rest state”. Such classification into at least these two types can recognize the time points of the start and the end of an action. Specifically, the range to be extracted from the body-conducted sound data as the information to detect an action can be precisely set, so that the precision in detecting an action can be enhanced.

The inclination calculator 5 calculates information (i.e., gradient per unit of time) of the inclination of a cepstrum coefficient. As illustrated in FIGS. 9A and 9B, using this information can precisely discriminate an action accompanying a low-frequency change in amplitude from an action not accompanying the change. For example, an action of cleaning a floor with a vacuum cleaner can be precisely discriminated from an action of brushing teeth. Consequently, the precision in detecting an action can be enhanced.

(6) The square error calculator 6 calculates the sum (i.e., the extent of the dispersion) of square errors of the average of the cepstrum coefficient. As illustrated in FIGS. 10A and 10B, using this information can precisely discriminate an action accompanying a high-frequency change in amplitude from an action not accompanying the change. For example, an action of tapping with a finger can be precisely discriminated from an action of flicking with a finger. Consequently, the precision in detecting an action can be enhanced.

(7) The primitive classification corrector 8 corrects (reclassifies) an action primitive in a unit of a minute time on the basis of the alignment of action primitives classified by the primitive classifier 4. Thereby, it is possible to correct the alignment of action primitives which alignment hardly appears in actuality. For example, when a “rest state” is sandwiched between two “motion states”, the “rest state” is determined to be the result of erroneous determination and corrected to the “motion state”. Likewise, when a “motion state” is sandwiched between two “rest states”, the “motion state” is determined to be the result of erroneous determination and corrected to the “rest state”. Such a correction (reclassification) of an action primitive can cancel the error occurred in the classification of action primitives and consequently, the precision in detecting an action can be enhanced.

(8) The action estimator 9 corrects and learns each probability model on the basis of values of a cepstrum coefficient, and calculates a likelihood of the alignment of action primitives corresponding to the probability model and outputs an action corresponding to the route and the identifier having the highest likelihood as the result of the estimating. This estimating manner can learn the probability model such that the probability model comes to be further appropriate. Advantageously, as denoted in Table 1, the precision of determining an action can be enhanced.

(9) Besides, correcting and learning a probability model using multiple component including at least the primary component c₁ of the cepstrum coefficient can further improve the precision of determining an action. For example, as compared with cases where only the MFCC primary component c₁ is used as denoted in Table 2, the case where the MFCC secondary component c₂ is used in combination with the MFCC primary component c₁ improves the precision in determining an action. Specifically, when the number of higher-order components to be used increases, the determination percentage increases. Determination using the MFCC primary component c₁ to the MFCC senary component c₆ can obtain the percentage rate over 80% for every fingertip action of the Table 2. Consequently, using higher-order cepstrum coefficients can enhance the precision in determining an action.

As described above, the technique disclosed herein can enhance the robustness of determination of an action by classifying the types of the action on the basis of time-division data obtained by time-dividing time-series data of the cepstrum coefficient of vibration.

8. Modification

Various changes and modifications to the above embodiment can be suggested without departing from the purpose of the above embodiment. The configuration and the processes of the above embodiment may be selected, omitted, or combined.

As illustrated in FIG. 1, the action detector 10 of the above embodiment is assumed to be a wearable device put on the wrist, but the position to wear the action detector 10 is not limited to the wrist. Alternatively, the action detector 10 may be put on an arm, a finger, an ankle, or a toe. The action detector 10 may be put on any position where body-conducted sound generated by an action of a limb can be detected.

In the above embodiment, an MFCC is used as a cepstrum coefficient, but the cepstrum coefficient is not limited to this. Alternatively, another cepstrum coefficient may be added or put in place of an MFCC. Using at least a multivariate obtained by orthogonalization of a logarithm spectrum of the body-conducted sound attains the same advantages as those of the above embodiment.

In the above embodiment, the functions illustrated in FIG. 3 are software stored in the auxiliary memory 23 or a removable medium. However, the article to store the software is not limited to these examples. Alternatively, the software may be provided in the form of being stored in a computer-readable recording medium such as a flexible disk, a CD, a DVD, and a Blu-ray disk. In this case, the computer reads the program from the recording medium and forwards the program to an internal memory to an external memory to store for future use. In the above embodiment, the entire function of FIG. 3 is achieved by software, but alternatively, the entire or part of the function may be achieved by hardware (i.e., logical circuit).

In the above embodiment, the computer 12 is a concept of a combination of hardware and an operating system (OS), and means hardware which operates under control of the OS. Otherwise, if a program does not need an OS but does operate hardware independently of an OS, the hardware itself corresponds to the computer. Hardware includes at least a microprocessor such as a CPU and means to read a computer program recorded in a recording medium. The program contains a program code to cause the above computer to achieve the functions of the action feature amount extractor 1 and action estimator 9 of the above embodiment. Part of the function may be achieved by OS, not by the application program.

All examples and conditional language recited herein are intended for pedagogical purposes to aid the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the purpose and scope of the invention.

What is claimed is:

1. A motion detector that detects an action of a limb, the motion detector comprising a processor configured to execute a process comprising:
extracting, as time-series data, a cepstrum coefficient of vibration generated by the action of the limb;
generating time-division data by time-dividing the time-series data; and
classifying a basic unit of the action corresponding to each of the time division data on the basis of the cepstrum coefficient included in the time-division data.

2. The motion detector according to claim 1, wherein the processor extracts at least a primary component of the cepstrum coefficient from the vibration.

3. The motion detector according to claim 1, wherein the processor further classifies the basic unit of the action into at least a rest state and a non-rest state on the basis of the cepstrum coefficient included in the time-division data.

4. The motion detector according to claim 3, wherein the processor further classifies the basic unit classified into the non-rest state into a motion state, an impact state, and a transition state on the basis of the cepstrum coefficient included in the time-division data.

5. The motion detector according to claim 1, wherein the processor further calculates a gradient per unit of time of the cepstrum coefficient included in the time-division data.

6. The motion detector according to claim 1, wherein the processor further calculates a degree of dispersion of the cepstrum coefficient included in the time-division data.

7. The motion detector according to claim 1, wherein the processor further reclassifies the basic unit of the action on the basis of an alignment of a plurality of the basic units of the action.

8. The motion detector according to claim 1, wherein the processor further estimates a type of the action on the basis of a likelihood of an alignment of the basic unit of the action corresponding to a probability model, and learns the probability model on the basis of the cepstrum coefficient.

9. The motion detector according to claim 8, wherein the processor further learns the probability model using multiple components, including at least a primary component, of the cepstrum coefficient.

10. A method for detecting an action of a limb, the method comprising:
at a processor
extracting, as time-series data, a cepstrum coefficient of vibration generated by the action of the limb;
generating time-division data by time-dividing the time-series data; and
classifying a basic unit of the action corresponding to the time division data on the basis of the cepstrum coefficient included in the time-division data.

11. The method according to claim 10, further comprising, at the processor, extracting at least a primary component of the cepstrum coefficient from the vibration.

12. The method according to claim 10, further comprising, at the processor, classifying the basic unit of the action into at least a rest state and a non-rest state on the basis of the cepstrum coefficient included in the time-division data.

13. The method according to claim 10, further comprising, at the processor, classifying the basic unit classified into the non-rest state into a motion state, an impact state, and a transition state on the basis of the cepstrum coefficient included in the time-division data.

14. The method according to claim 10, further comprising, at the processor, calculating a gradient per unit of time of the cepstrum coefficient included in the time-division data.

15. The method according to claim 10, further comprising, at the processor, calculating a degree of dispersion of the cepstrum coefficient included in the time-division data.

16. The method according to claim 10, further comprising, at the processor, reclassifying the basic unit of the action on the basis of an alignment of a plurality of the basic units of the action.

17. The method according to claim 10, further comprising, at the processor, estimating a type of the action on the basis of a likelihood of an alignment of the basic unit of the action corresponding to a probability model, and learning the probability model on the basis of the cepstrum coefficient.

18. The method according to claim 17, further comprising, at the processor, learning the probability model using multiple components, including at least a primary component, of the cepstrum coefficient.

19. A computer-readable recording medium having stored therein a program for causing a computer to execute a process of detecting an action of a limb, the process comprising:
extracting, as time-series data, a cepstrum coefficient of vibration generated by the action of the limb;
generating time-division data by time-dividing the time-series data; and
classifying a basic unit of the action corresponding to the time division data on the basis of the cepstrum coefficient included in the time-division data.
